(19) United States
(12) Patent Application Publication
(10) Pub. No.: US 2026/0342472 A1
(43) Pub. Date: Oct. 29, 2026

(54) CODEC BITRATE ADAPTATION

(71) Applicant: Nokia Technologies Oy, Espoo (FI)

(72) Inventors: Pingping WEN, Shanghai (CN); Ping YUAN, Beijing (CN)

(73) Assignee: Nokia Technologies Oy, Espoo (FI)

(21) Appl. No.: 19/103,655

(22) PCT Filed: Aug. 17, 2022
(86) PCT No.: PCT/CN2022/113145

§ 371 Date: Feb. 13, 2025

(51) Int. Cl. H04L 1/00; H04L 65/65

(52) U.S. Cl. CPC H04L 1/0009; H04L 1/0002; H04L 65/65

(57) ABSTRACT

Embodiments of the present disclosure relate to codec bitrate adaptation. A terminal device negotiates, with a second terminal device, a first codec bitrate supported by the first terminal device for voice communicating with the second terminal device. The terminal device receives, from the second terminal device, a second codec bitrate supported by the second terminal device for voice communicating with the first terminal device. Based on the second codec bitrate, the terminal device determines a third codec bitrate supported by the first terminal device for voice communicating with the second terminal device, the third codec bitrate being less than or equal to the second codec bitrate. In this way, the unnecessary access network bitrate recommendation (ANBR) procedure may be avoided, thereby reducing the latency of codec adaptation as well as the voice packet loss in the case of bitrate increase considering the pathloss change trend in NTN system.

### FIELD

Various example embodiments relate to the field of telecommunication and in particular, to methods, devices, apparatuses and a computer readable storage medium for codec bitrate adaptation.

### BACKGROUND

With the development of communication systems, new technologies have been proposed. Third Generation Partnership Project (3GPP) has defined a work item (WI) for Release 17 (Rel-17) on non-terrestrial networks (NTN) in RP-201256 and the further enhancement will be continued in Rel-18 in work item description (WID) RP-220953. One item of next step of the study is to improve the performance of low-rate codecs in link budget limited situation. It still needs to further improve the solution of codec bitrate adaptation.

### SUMMARY

In general, example embodiments of the present disclosure provide a solution for codec bitrate adaptation.

In a first aspect, there is provided a first terminal device. The first terminal device comprises at least one processor and at least one memory storing instructions. The instructions are configured to, when executed by the at least one processor, cause the first terminal device to negotiate, with a second terminal device, a first codec bitrate supported by the first terminal device for voice communicating with the second terminal device; receive, from the second terminal device, a second codec bitrate supported by the second terminal device for voice communicating with the first terminal device; and determine, based on the second codec bitrate, a third codec bitrate supported by the first terminal device for voice communicating with the second terminal device, the third codec bitrate being less than or equal to the second codec bitrate.

In a second aspect, there is provided a second terminal device. The second terminal device comprises at least one processor and at least one memory storing instructions. The instructions are configured to, when executed by the at least one processor, cause the second terminal device to negotiate, with a first terminal device, a first codec bitrate supported by the second terminal device for voice communicating with the first terminal device; determine a second codec bitrate supported by the second terminal device for voice communicating with the first terminal device, based on motion of a second network device serving the second terminal device relative to the second terminal device; and send the second codec bitrate to the first terminal device.

In a third aspect, there is provided a first network device. The first network device comprises at least one processor and at least one memory storing instructions. The instructions are configured to, when executed by the at least one processor, cause the first network device to receive, from a first terminal device, a second codec bitrate supported by a second terminal device for voice communicating with the first terminal device; determine, based on the second codec bitrate, a third codec bitrate supported by the first terminal device for voice communicating with the second terminal device, the third codec bitrate being less than or equal to the second codec bitrate; and send the third codec bitrate to the first terminal device.

In a fourth aspect, there is provided a second network device. The second network device comprises at least one processor and at least one memory storing instructions. The instructions are configured to, when executed by the at least one processor, cause the second network device to receive, from a second terminal device, a reference signal receiving power (RSRP) or a second pathloss associated with the second terminal device and a previous codec bitrate supported by the second terminal device for voice communicating with a first terminal device; determine, based on the RSRP or the second pathloss and the previous codec bitrate, a second codec bitrate supported by the second terminal device for voice communicating with the first terminal device; and send the second codec bitrate to the second terminal device.

In a fifth aspect, there is provided a second network device. The second network device comprises at least one processor and at least one memory storing instructions. The instructions are configured to, when executed by the at least one processor, cause the second network device to determine, for a second terminal device, a mapping between a second codec bitrate supported by the second terminal device for voice communicating with a first terminal device and a reference signal receiving power (RSRP) or a second pathloss associated with the second terminal device; and send the mapping to the second terminal device.

In a sixth aspect, there is provided a method. The method comprises negotiating, at a first terminal device with a second terminal device, a first codec bitrate supported by the first terminal device for voice communicating with the second terminal device; receiving, from the second terminal device, a second codec bitrate supported by the second terminal device for voice communicating with the first terminal device; and determining, based on the second codec bitrate, a third codec bitrate supported by the first terminal device for voice communicating with the second terminal device, the third codec bitrate being less than or equal to the second codec bitrate.

In a seventh aspect, there is provided a method. The method comprises negotiating, at a second terminal device with a first terminal device, a first codec bitrate supported by the second terminal device for voice communicating with the first terminal device; determining a second codec bitrate supported by the second terminal device for voice communicating with the first terminal device, based on motion of a second network device serving the second terminal device relative to the second terminal device; and sending the second codec bitrate to the first terminal device.

In an eighth aspect, there is provided a method. The method comprises receiving, at a first network device from a first terminal device, a second codec bitrate supported by a second terminal device for voice communicating with the first terminal device; determining, based on the second codec bitrate, a third codec bitrate supported by the first terminal device for voice communicating with the second terminal device, the third codec bitrate being less than or equal to the second codec bitrate; and sending the third codec bitrate to the first terminal device.

In a ninth aspect, there is provided a method. The method comprises receiving, at a second network device from a second terminal device, a reference signal receiving power (RSRP) or a second pathloss associated with the second terminal device and a previous codec bitrate supported by the second terminal device for voice communicating with a first terminal device; determining, based on the RSRP or the second pathloss and the previous codec bitrate, a second codec bitrate supported by the second terminal device for voice communicating with the first terminal device; and sending the second codec bitrate to the second terminal device.

In a tenth aspect, there is provided a method. The method comprises determining, at a second network device for a second terminal device, a mapping between a second codec bitrate supported by the second terminal device for voice communicating with a first terminal device and a reference signal receiving power (RSRP) or a second pathloss associated with the second terminal device; and sending the mapping to the second terminal device.

In a eleventh aspect, there is provided an apparatus comprising means for negotiating, at a first terminal device with a second terminal device, a first codec bitrate supported by the first terminal device for voice communicating with the second terminal device; means for receiving, from the second terminal device, a second codec bitrate supported by the second terminal device for voice communicating with the first terminal device; and means for determining, based on the second codec bitrate, a third codec bitrate supported by the first terminal device for voice communicating with the second terminal device, the third codec bitrate being less than or equal to the second codec bitrate.

In a twelfth aspect, there is provided an apparatus comprising means for negotiating, at a second terminal device with a first terminal device, a first codec bitrate supported by the second terminal device for voice communicating with the first terminal device; means for determining a second codec bitrate supported by the second terminal device for voice communicating with the first terminal device, based on motion of a second network device serving the second terminal device relative to the second terminal device; and means for sending the second codec bitrate to the first terminal device.

In a thirteenth aspect, there is provided an apparatus comprising means for receiving, at a first network device from a first terminal device, a second codec bitrate supported by a second terminal device for voice communicating with the first terminal device; means for determining, based on the second codec bitrate, a third codec bitrate supported by the first terminal device for voice communicating with the second terminal device, the third codec bitrate being less than or equal to the second codec bitrate; and means for sending the third codec bitrate to the first terminal device.

In a fourteenth aspect, there is provided an apparatus comprising means for receiving, at a second network device from a second terminal device, a reference signal receiving power (RSRP) or a second pathloss associated with the second terminal device and a previous codec bitrate supported by the second terminal device for voice communicating with a first terminal device; means for determining, based on the RSRP or the second pathloss and the previous codec bitrate, a second codec bitrate supported by the second terminal device for voice communicating with the first terminal device; and means for sending the second codec bitrate to the second terminal device.

In a fifteenth aspect, there is provided an apparatus comprising means for determining, at a second network device for a second terminal device, a mapping between a second codec bitrate supported by the second terminal device for voice communicating with a first terminal device and a reference signal receiving power (RSRP) or a second pathloss associated with the second terminal device; and means for sending the mapping to the second terminal device.

In a sixteenth aspect, there is provided a non-transitory computer readable medium comprising program instructions for causing an apparatus to perform at least the method according to any one of the above third or fourth aspect.

In a seventeenth aspect, there is provided a computer program comprising instructions, which, when executed by an apparatus, cause the apparatus at least to: negotiate, with a second terminal device, a first codec bitrate supported by the first terminal device for voice communicating with the second terminal device; receive, from the second terminal device, a second codec bitrate supported by the second terminal device for voice communicating with the first terminal device; and determine, based on the second codec bitrate, a third codec bitrate supported by the first terminal device for voice communicating with the second terminal device, the third codec bitrate being less than or equal to the second codec bitrate.

In an eighteenth aspect, there is provided a computer program comprising instructions, which, when executed by an apparatus, cause the apparatus at least to: negotiate, with a first terminal device, a first codec bitrate supported by the second terminal device for voice communicating with the first terminal device; determine a second codec bitrate supported by the second terminal device for voice communicating with the first terminal device, based on motion of a second network device serving the second terminal device relative to the second terminal device; and send the second codec bitrate to the first terminal device.

In a nineteenth aspect, there is provided a computer program comprising instructions, which, when executed by an apparatus, cause the apparatus at least to: receive, from a first terminal device, a second codec bitrate supported by a second terminal device for voice communicating with the first terminal device; determine, based on the second codec bitrate, a third codec bitrate supported by the first terminal device for voice communicating with the second terminal device, the third codec bitrate being less than or equal to the second codec bitrate; and send the third codec bitrate to the first terminal device.

In a twentieth aspect, there is provided a computer program comprising instructions, which, when executed by an apparatus, cause the apparatus at least to: receive, from a second terminal device, a reference signal receiving power (RSRP) or a second pathloss associated with the second terminal device and a previous codec bitrate supported by the second terminal device for voice communicating with a first terminal device; determine, based on the RSRP or the second pathloss and the previous codec bitrate, a second codec bitrate supported by the second terminal device for voice communicating with the first terminal device; and send the second codec bitrate to the second terminal device.

In a twenty-first aspect, there is provided a computer program comprising instructions, which, when executed by an apparatus, cause the apparatus at least to: determine, for a second terminal device, a mapping between a second codec bitrate supported by the second terminal device for voice communicating with a first terminal device and a reference signal receiving power (RSRP) or a second pathloss associated with the second terminal device; and send the mapping to the second terminal device.

In a twenty-second aspect, there is provided a first terminal device. The first terminal device comprises negotiating circuitry configured to negotiate, with a second terminal device, a first codec bitrate supported by the first terminal device for voice communicating with the second terminal device; receiving circuitry configured to receive, from the second terminal device, a second codec bitrate supported by the second terminal device for voice communicating with the first terminal device; and determining circuitry configured to determine, based on the second codec bitrate, a third codec bitrate supported by the first terminal device for voice communicating with the second terminal device, the third codec bitrate being less than or equal to the second codec bitrate.

In a twenty-third aspect, there is provided a second terminal device. The second terminal device comprises negotiating circuitry configured to negotiate, with a first terminal device, a first codec bitrate supported by the second terminal device for voice communicating with the first terminal device; determining circuitry configured to determine a second codec bitrate supported by the second terminal device for voice communicating with the first terminal device, based on motion of a second network device serving the second terminal device relative to the second terminal device; and sending circuitry configured to send the second codec bitrate to the first terminal device.

In a twenty-fourth aspect, there is provided a first network device. The first network device comprises receiving circuitry configured to receive, from a first terminal device, a second codec bitrate supported by a second terminal device for voice communicating with the first terminal device; determining circuitry configured to determine, based on the second codec bitrate, a third codec bitrate supported by the first terminal device for voice communicating with the second terminal device, the third codec bitrate being less than or equal to the second codec bitrate; and sending circuitry configured to send the third codec bitrate to the first terminal device.

In a twenty-fifth aspect, there is provided a second network device. The second network device comprises receiving circuitry configured to receive, from a second terminal device, a reference signal receiving power (RSRP) or a second pathloss associated with the second terminal device and a previous codec bitrate supported by the second terminal device for voice communicating with a first terminal device; determining circuitry configured to determine, based on the RSRP or the second pathloss and the previous codec bitrate, a second codec bitrate supported by the second terminal device for voice communicating with the first terminal device; and sending circuitry configured to send the second codec bitrate to the second terminal device.

In a twenty-sixth aspect, there is provided a second network device. The second network device comprises determining circuitry configured to determine, for a second terminal device, a mapping between a second codec bitrate supported by the second terminal device for voice communicating with a first terminal device and a reference signal receiving power (RSRP) or a second pathloss associated with the second terminal device; and sending circuitry configured to send the mapping to the second terminal device.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication network in which embodiments of the present disclosure may be implemented;

FIG. 2 illustrates a signaling chart illustrating an example process according to some embodiments of the present disclosure;

FIG. 3 illustrates an example of an optimized codec bitrate adaptation procedure which may be used in example embodiments of the present disclosure;

FIG. 4 illustrates an example of another optimized codec bitrate adaptation procedure which may be used in example embodiments of the present disclosure;

FIG. 5 illustrates a flowchart of a method implemented at a terminal device according to some embodiments of the present disclosure;

FIG. 6 illustrates a flowchart of a method implemented at a terminal device according to some embodiments of the present disclosure;

FIG. 7 illustrates a flowchart of a method implemented at a network device according to some embodiments of the present disclosure;

FIG. 8 illustrates a flowchart of a method implemented at a network device according to some embodiments of the present disclosure;

FIG. 9 illustrates a flowchart of a method implemented at a network device according to some embodiments of the present disclosure;

FIG. 10 illustrates a simplified block diagram of an apparatus that is suitable for implementing embodiments of the present disclosure; and

FIG. 11 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT), Non-terrestrial network (NTN) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, the sixth generation (6G) communication protocols and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, a non-terrestrial network (NTN) or non-ground network device such as a satellite network device, a low earth orbit (LEO) satellite, a medium earth orbit (MEO) satellite and a geosynchronous earth orbit (GEO) satellite, an aircraft network device, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

A non-terrestrial network (NTN) refers to a network or a segment of the network which uses typical technologies such as satellites and high-altitude platforms to participate in network deployment compared with traditional terrestrial networks (TN). The NTN may provide an NTN cell that covers a wider range than a TN cell provided by a TN. Typical NTN scenarios that can be foreseen include situations where base stations cannot be built and base stations are damaged, such as continuous coverage in remote mountainous areas, deserts, oceans, and forests, or emergency communications when disasters occur and base stations are damaged. The industry summarizes typical NTN scenarios as all-terrain coverage, signaling offload, emergency communications, Internet of Things, and broadcasting services.

3GPP has defined a work item for Rel-17 on NTN in RP-201256 and further enhancement will be continued in Rel-18 in WID RP-220953. One objective of this Rel-18 WI is to consider coverage enhancement. There is a 6-month study phase focusing on the following (to derive clear & limited scope):
Evaluate the coverage performance and identify the candidate physical radio channels that have coverage issues specific to NTN with the following target services taking into account the studies in technical report (TR) 38.830 where appropriate, as well as general coverage enhancement techniques specified in Rel-18 [RAN1,RAN2,RAN4];
   VOIP and low-data rate services for commercial handset terminals.

The following items are shown as examples of areas to consider in the next step of the study:
NTN-specific repetitions enhancements beyond techniques covered in Rel-17 coverage enhancement WI for the relevant channels;
NTN-specific techniques for improved diversity and/or reduced polarization loss;
Improved performance of low-rate codecs in link budget limited situation including reducing radio access network (RAN) protocol overhead for voice over Internet protocol (VOIP) over new radio (NR).

Based above information, to support VoIP over NR (VoNR) in NTN for commercial handset terminals and improve the performance of low-rate codecs in link budget limited situation should be studied in R18 NTN WI.

According to TS 26.114, a UE offering speech communication shall support narrowband (adaptive multi-rate, AMR, speech codec), wideband (AMR-WB), and super-wideband (enhance voice services, EVS) communication. The supported codec mode can be summarized below table 1.

TABLE 1
Codec mode with different codec bitrate

| | Codec mode with different codec bitrate (in kbps) | | | | | | | | | | |
|---|---|---|---|---|---|---|---|---|---|---|---|
| AMR(NB) | 4.75 | 5.15 | 5.9 | 6.7 | 7.4 | 7.95 | 10.2 | 12.2 | | | |
| AMR-WB | 6.6 | 8.85 | 12.65 | 14.25 | 15.85 | 18.25 | 19.85 | 23.05 | 23.85 | | |
| EVS | 7.2 | 8 | 9.6 | 13.2 | 16.4 | 24.4 | 32 | 48 | 64 | 96 | 128 |

As shown in Table 1, the codec bitrate of EVS is much bigger than the codec bitrate of AMR. A higher AMR voice code rate may provide a higher-definition voice call and accordingly a better user experience. Due to each VoIP packet being generated with a periodicity 20 ms, the higher the codec bitrate used, the more real-time transport protocol (RTP) payload will be generated. Table 2 gives the example to illustrate the transport block size (TBS) to accommodate the VOIP payload as well as RTP/user datagram protocol (UDP)/Internet protocol (IP) headers and medium access control (MAC) headers. When UE's codec rate changes from 4.75 Kbps to 12.2 Kbps, the required TBS will increase from 184 bits to 328 bits.

TABLE 2
TBS for different Codec mode

| | | | | | | | | |
|---|---|---|---|---|---|---|---|---|
| Mode | 4.75 | 5.15 | 5.9 | 6.7 | 7.4 | 7.95 | 10.2 | 12.2 |
| Bits per speech frame | 95 | 103 | 118 | 134 | 148 | 159 | 204 | 244 |
| Payload header and ToC | 10 | 10 | 10 | 10 | 10 | 10 | 10 | 10 |
| RTP payload (bits) | 105 | 113 | 128 | 144 | 158 | 169 | 214 | 254 |
| RTP payload (bytes) | 13.13 | 14.13 | 16 | 18 | 19.75 | 21.13 | 26.75 | 31.75 |
| Rounded-up RTP | 14 | 15 | 16 | 18 | 20 | 22 | 27 | 32 |
| payload (bytes) | | | | | | | | |
| Rounded-up RTP | 112 | 120 | 128 | 144 | 160 | 176 | 216 | 256 |
| payload (bits) | | | | | | | | |
| RTP header | 96 | 96 | 96 | 96 | 96 | 96 | 96 | 96 |
| UDP header | 64 | 64 | 64 | 64 | 64 | 64 | 64 | 64 |
| IPv4 header | 160 | 160 | 160 | 160 | 160 | 160 | 160 | 160 |
| Total bits | 432 | 440 | 448 | 464 | 480 | 496 | 536 | 576 |
| per 20 ms | | | | | | | | |
| After RoHC | 152 | 160 | 168 | 184 | 200 | 216 | 256 | 296 |
| (40 bits) | | | | | | | | |
| TBS to accommodate | 184 | 192 | 200 | 216 | 232 | 248 | 288 | 328 |
| payload, RoHC and | | | | | | | | |
| PDCP/RLC/MAC CE | | | | | | | | |
| (32 bits) | | | | | | | | |

RAN-assisted Codec adaptation for VOIP calls was discussed in LTE under WID RP-160563. Codec mode and codec rate can be selected and determined based on the radio conditions. For example, in poor radio conditions, a lower codec rate may be used to generate small RTP payload and reduce the packet loss as well as end to end (E2E) latency and jitter. On the other hand, a higher codec rate can be used in good radio conditions to ensure a better user experience of the VoNR call. The outcome of the corresponding study item can be found in TR36.750.

In case an eNB determines to recommend a UE in RRC_CONNECTED mode to modify the bit rate due to e.g. poor radio conditions or network congestion detected in the uplink or downlink transmission direction, it may signal a recommended bit rate to that UE. The UE may use the recommended bit rate as an input to initiate an end-to-end rate adaptation by sending an application layer message (e.g. RTP control protocol (RTCP) or RTP codec mode request (CMR)) to the peer UE or the concerning media gateway (GW). Accordingly, the peer UE may retrieve a recommended bit rate from its serving eNB to ensure E2E codec adaptation.

In a current solution of codec bitrate adaptation, E2E voice codec adaptation is based on access network bitrate recommendation (ANBR) mechanism defined in RAN as agreed in LTE and NR. The details of ANBR mechanism can be found in TS26.114 section 10.7 where the message ANBR is mapped to a MAC level message named “Recommended bit rate MAC Control Element” and the message access network bitrate recommendation query (ANBRQ) is mapped to a MAC level message named “Recommended bit rate query MAC Control Element”. The “Request max” message is a generalized application level message that corresponds to RTP CMR or application-defined RTP control protocol packet (RTCP-APP) for voice.

In a current solution of codec bitrate adaptation, a Multimedia Telephony Service for IP multimedia subsystem (MTSI) client in a terminal that receives both ANBR with bitrate R1 and a “Request max” message with bitrate R0 for its media sending direction shall use min (R0, R1) as the combined bitrate for those two adaptation triggers. When an MTSI client in terminal (e.g. UE1) receives an ANBR message for the local uplink that triggers an adaptation decision, if an adaptation resulting in an increase of the media sender bitrate (e.g. R2) in uplink, it may result in an increase of media sender bitrate at the earliest opportunity, taking other adaptation triggers into account. When the peer MTSI client in terminal (e.g. UE2) receives application signaling for bitrate adaptation of media, such as frame type indicator (for speech) that result in an increase of the media sender bitrate, UE2 shall take all available adaptation triggers for the local downlink into account, e.g. any bitrate limit from the most recently received ANBR message. If the UE2 has reason to believe that the most recently received ANBR for its downlink no longer applies, it may send an ANBRQ message in its uplink to query network (NW) whether the increased bitrate (R2) can be supported from NW point of view. Based on NW's decision (e.g. received RF metrics channel quality indicator (CQI) or reference signal receiving power (RSRP) from UE and the NW's overload status), NW may indicate the recommend bitrate to UE (e.g. R3 which is smaller than R2) in ANBR. Hence the UE2 may initialize the codec change negotiated with UE1 again.

Similarly, when an MTSI client in terminal (UE1) receives an ANBR message for the local downlink that triggers an adaptation decision, adaptation signalling to match the local downlink restriction shall be initiated towards the remote media sender. Similarly, UE 2 may trigger ANBRQ and ANBR procedure again to check whether the increased bitrate can be supported.

Based on above signaling procedure, if a voice codec adaptation results in an increase of the media bitrate, the remote terminal (peer node) received application signalling for bitrate adaptation will trigger an adaptation decision. It needs at least one RTT for the ANBRQ and ANBR message transmission between the terminal and network. Due to the large latency in the NTN system, the codec adaptation procedure will take a quite long time, especially when the remote terminal can't accept the increased bitrate, it may take up to three RTTs to successfully negotiate the increased bitrate.

The delay of codec adaptation negotiation may cause the voice packet loss occur for the longer time in NTN system compared with TN system. For example, the UE1 applies the increased bitrate in voice packets while the UE2 cannot support it which may cause voice packet loss until codec adaptation negotiation is done. Furthermore, the delay of codec adaptation may delay when the higher codec rate can be used in good radio conditions to ensure a better user experience of the VoNR call.

For NTN, the satellites in non-GEO orbits move with high-speed relative to a fixed position on earth, the distance and pathloss between satellite and UE is continuously changing. When the satellite is moving away from the UE, the change of pathloss is positive. When the satellite is moving towards the UE, the change of pathloss is negative. Therefore, the change trend of the pathloss and the code bitrate of one UE can be predictive to some extent.

According to embodiments of the present disclosure, there is provided a solution for codec bitrate adaptation. In this solution, a first terminal device negotiates, with a second terminal device, a first codec bitrate supported by the first terminal device for communicating with the second terminal device. The first terminal device receives, from the second terminal device, a second codec bitrate supported by the second terminal device for communicating with the first terminal device, and determines, based on the second codec bitrate, a third codec bitrate supported by the first terminal device for communicating with the second terminal device, the third codec bitrate being less than or equal to the second codec bitrate.

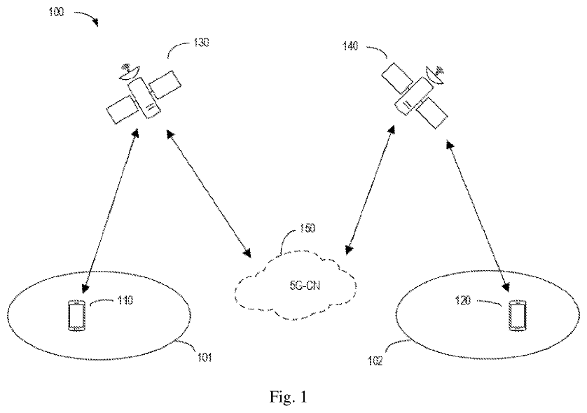

Moreover, a second terminal device negotiates, with a first terminal device, a first codec bitrate supported by the second terminal device for communicating with the first terminal device; determine a second codec bitrate supported by the second terminal device for communicating with the first terminal device, based on motion of the second terminal device relative to a second network device serving the second terminal device; and send the second codec bitrate to the first terminal device. As such, the unnecessary ANBR procedure may be avoided, thereby reducing the latency of codec adaptation as well as the voice packet loss in the case of bitrate increase considering the pathloss change trend in NTN system. Example embodiments of the present disclosure for determination of the terminal device's identity will be described below with reference to FIGS. 1-11.

FIG. 1 illustrates an example network environment 100 in which example embodiments of the present disclosure may be implemented. The environment 100, which may be a part of a communication network, comprises a UE 110, a UE 120, a satellite 130, and a satellite 140. As illustrated in FIG. 1, the satellite 130 (also referred as “a first satellite 130” or “a first network device 130” in the following) provides and manages a serving cell 101, and the satellite 140 (also referred as “a second satellite 140” or “a second network device 140” in the following) provides and manages a serving cell 102.

The UE 110 (also referred as “a first terminal device 110” or “a first user equipment 110” in the following) and the satellite 130 may communicate data and control information to each other in the coverage of the serving cell 101. A link from the satellite 130 to the UE 110 is referred to as a downlink (DL), while a link from the UE 110 to the satellite 130 is referred to as an uplink (UL). In the same way, The UE 120 (also referred as “a second terminal device 120” or “a second user equipment 120” in the following) and the satellite 140 may communicate data and control information to each other in the coverage of the serving cell 102. The UE 110 may communicate with the UE 120 via the satellite 130 and the satellite 140.

In a scenario of NTN, the satellites 130 and 140 may serve as base stations (BS) providing serving cells for the UEs 110 and 120, and the satellites 130 and 140 further communicate with a 5G core network (5G-CN) 150 via gateway devices (not shown in FIG. 1). In some other embodiments, the satellites 130 and 140 may serve as network relay nodes between the UEs and the BSs.

It is to be understood that the number of network devices and terminal devices is only for the purpose of illustration without suggesting any limitations. The system 100 may include any suitable number of network devices and terminal devices adapted for implementing embodiments of the present disclosure. Although not shown, it would be appreciated that one or more terminal devices may be located in the environment 100.

Communications in the communication system 100 may be implemented according to any proper communication protocol(s), comprising, but not limited to, cellular communication protocols of the first generation (1G), the second generation (2G), the third generation (3G), the fourth generation (4G), the fifth generation (5G) and the sixth generation (6G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

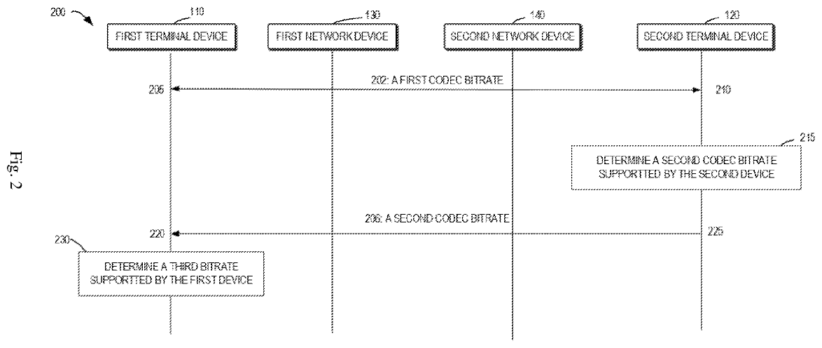

FIG. 2 illustrates a signaling chart illustrating an example process according to some embodiments of the present disclosure. For the purpose of discussion, the process 200 will be described with reference to FIG. 1. The process 200 may involve the first terminal device 110, the second terminal device 120, the first network device 130, and the second network device 140 as illustrated in FIG. 1. It would be appreciated that although the process 200 for link has been described in the communication system 100 of FIG. 1, this process may be likewise applied to other communication scenarios.

In the process flow 200, the first terminal device 110 negotiates 205 a first codec bitrate 202 with the second terminal device 120. The first codec bitrate 202 is supported by the first terminal device 110 for voice communicating with the second terminal device 120. On the other side of the communication, the second terminal device 120 negotiates 210 the first codec bitrate 202 with the first terminal device 110. The first codec bitrate 202 is also supported by the second terminal device 120 for voice communicating with the first terminal device 110. In some embodiments, the voice terminals (e.g. the first terminal device 110 and the second terminal device 120) negotiate a max bitrate R0, the two terminals have communication with bitrate R1 (R1<R0) during the on-going call.

After negotiating 210 the first codec bitrate 202 with the first terminal device 110, the second terminal device 120 determines 215 a second codec bitrate 206 supported by the second terminal device 120 for voice communicating with the first terminal device 110 based on motion of a second network device 140 serving the second terminal device 120 relative to the second terminal device 120. Then the second terminal device 120 sends 225 the second codec bitrate 206 to the first terminal device 110.

After receiving 220 the second codec bitrate 206 from the second terminal device 120, the first terminal device 110 determines 230 a third codec bitrate supported by the first terminal device 110 for voice communicating with the second terminal device 120 based on the second codec bitrate 206. The third codec bitrate is less than or equal to the second codec bitrate 206. Through the process flow 200, a maximum codec bitrate supported by the second terminal 120 can be sent to the first terminal device 110, thereby unnecessary access network bitrate recommendation (ANBR) procedure may be avoided.

In some embodiments, the first terminal device 110 may further send a first change trend of a first channel condition between a first network device 130 serving the first terminal device 110 and the first terminal device 110 to the second terminal device 120 during the negotiating of the first codec bitrate 202; and receive a second change trend of a second channel condition between a second network device 140 serving the second terminal device 120 and the second terminal device 120 from the second terminal device 120 during the negotiating of the first codec bitrate 202.

In some embodiments, the first channel condition is a first pathloss associated with the first terminal device, and the first pathloss decreasing corresponds to the first channel condition becoming better, the first pathloss increasing corresponds to the first channel condition becoming worse; or the second channel condition is a second pathloss associated with the second terminal device, and the second pathloss decreasing corresponds to the second channel condition becoming better, and the second pathloss increasing corresponds to the second channel condition becoming worse.

In some embodiments, in order to receive the second codec bitrate 206, the first terminal device 110 may receive a step size of a change to a previous codec bitrate supported by the second terminal device for voice communicating with the first terminal device from the second terminal device 120, and determine the second codec bitrate 206 based on the previous codec bitrate and the step size. For example, the second terminal device 120 may also inform the first terminal device 110 the step size(s) for the max supported codec data rate increase/decrease. In the case that there is no bitrate change between the first terminal device 110 and the second terminal device 120 after negotiating 210 the first codec bitrate 202, the previous codec bitrate refers to the first codec bitrate. In the case of bitrate changes between the first terminal device 110 and the second terminal device 120 after negotiating 210 the first codec bitrate 202, the previous codec bitrate refers to a codec bitrate supported by the first terminal device 110 and the second terminal device 120 after the last change.

In some embodiments, in order to determine the step size, the first terminal device 110 may determine the step size as a positive value based on determining that the second network device 140 is moving towards the second terminal device 120. And the first terminal device 110 may determine the step size as a negative value based on determining that the second network device 140 is moving away from the second terminal device 120.

In some embodiments, in order to determine the second codec bitrate 206, the first terminal device 110 may increase the previous codec bitrate by the step size to obtain the second codec bitrate 206 based on determining that the second change trend indicates a decrease of the second pathloss. And the first terminal device 110 may decrease the previous codec bitrate by the step size to obtain the second codec bitrate 206 based on determining that the second change trend indicates an increase of the second pathloss. For example, if one UE (e.g., the second terminal device 120) is moving towards the satellite, the step size can be one positive value. If one UE (e.g., the second terminal device 120) is moving away from the satellite, the step size can be one negative value. This can be implemented since the pathloss change trend is exchanged in 205. With the received step size, the peer UE (e.g., the first terminal device 110) can derive a new maximum bitrate for the second terminal device 120 accordingly.

In some embodiments, the first terminal device 110 may send information indicating that the first change trend varies to the second terminal device 120 based on determining that the first change trend varies. Moreover, the first terminal device 110 can receive information indicating that the second change trend varies from the second terminal device 120. For example, when the pathloss change trend varies in some cases, e.g., in handover, the UE will inform this information to another remote UE, e.g., via RTCP-APP.

In some embodiments, in order to determine the third codec bitrate, the first terminal device 110 may send the second codec bitrate 206 to the first network device 130 serving the first terminal device 110. The first network device 130 determines a third codec bitrate supported by the first terminal device 110 based on the second codec bitrate 206, and sends the third codec bitrate to the first terminal device 110. For example, in order to determine the max bitrate R2, the first terminal device 110 may send the new max bitrate (i.e. R3/R4) or step size supported by the second terminal device 120 to the first network device 130, and the first network device 130 determines the max bitrate R2 supported by the first terminal device 110 based on the new max bitrate (i.e. R3/R4) and the current channel condition, and the max bitrate R2 less than or equal to the R3/R4. Then the first network device 130 sends the max bitrate R2 to the first terminal device 110.

In some embodiments, in order to determine the third codec bitrate, the first terminal device 110 may receive a fourth codec bitrate supported by the first terminal device 110 from a first network device 130 serving the first terminal device 110, the fourth codec bitrate may be used to voice communicating with the second terminal device 120. And the first terminal device 110 can determine a smaller one of the second codec bitrate 206 and the fourth codec bitrate as the third codec bitrate. For example, in order to determine the max bitrate R2, the first network device 130 can determine a max bitrate R5 based on the current channel condition, and send the max bitrate R5 to the first terminal device 110. The first terminal device 110 determines the max bitrate R2 supported by the first terminal device 110 based on the max bitrate R5 and the new max bitrate supported by the second terminal device 120 (i.e. R3/R4), and the max bitrate R2 less than or equal to the R3/R4.

For example, the first terminal device 110 and the first network device 130 may determine a max bitrate R2 (<R3/R4) supported by the first terminal device 110. With this new changed max bitrate (i.e. R3/R4) or step size, if the UE (e.g., the first terminal device 110) determines to increase the codec data rate, the new increased codec data rate shall not be larger than the new max bitrate supported by the second terminal device 120. Thus avoid the ANBR procedure in the second terminal device 120 when the first terminal device 110 receives the increased bitrate requirement as well as reduce the packet loss.

In some embodiments, the second codec bitrate 206 is carried in a codec mode request (CMR) in a real-time transport protocol (RTP) or carried in an application-defined RTP control protocol packet (RTCP-APP) message, and the third codec bitrate is carried in a recommended bit rate medium access control (MAC) control element (CE).

In some embodiments, in order to determine the second codec bitrate 206, the second terminal device 120 may increase the previous codec bitrate to obtain the second codec bitrate 206 based on determining that the second network device 140 is moving towards the second terminal device 120, and reduce the previous codec bitrate to obtain the second codec bitrate 206 based on determining that the second network device 140 is moving away from the second terminal device 120. For example, if one UE (e.g. the second terminal device 120) is moving away from the satellite (e.g. the second network device 140), the UE may determine that the supported maximum bitrate may be reduced with the movement of the satellite and the support maximum bitrate changes to R3 (R3<R0). Alternatively, when the UE (e.g., the second terminal device 120) is moving toward the satellite, the UE determines that the supported maximum bitrate may be increased with the movement of the satellite and the supported maximum bitrate changes to R4 (R4>R0). Then the UE will inform the peer UE (e.g., the first terminal device 110) which is communicating that the changed max bitrate R3 or R4. This information can be carried in CMR in RTP or RTCP-APP message.

In some embodiments, the second terminal device 120 may determine the second codec bitrate 206 by determining a step size of a change from the previous codec bitrate to the second codec bitrate 206. In some embodiments, the second terminal device 120 may determine the step size as a positive value based on determining that the second network device 140 is moving towards the second terminal device 120. And the second terminal device 120 may determine the step size as a negative value based on determining that the second network device 140 is moving away from the second terminal device 120.

In some embodiments, the second terminal device 120 may determine that the first pathloss associated with the first terminal device 110 is decreased based on the first change trend. Then the second terminal device 120 sends the second codec bitrate 206 to the first terminal device 110 after determining that the first pathloss is decreased. For example, the second terminal device 120 only sends the changed max bitrate/step size to peer the first terminal device 110 when the pathloss of the first terminal device 110 becomes smaller (i.e., the satellite is moving towards the first terminal device 110 and the bit rate is possibly increased). This can be implemented since the pathloss change trend is exchanged in 210.

In some embodiments, in order to determine the second codec bitrate 206, the second terminal device 120 may send a reference signal receiving power (RSRP) or a second pathloss associated with the second terminal device and the previous codec bitrate to the second network device 140. After the second network device 140 determined the second codec bitrate 206, the second terminal device 120 receives the second codec bitrate 206 from the second network device 140.

In some embodiments, in order to determine the second codec bitrate 206, the second terminal device 120 may receive a mapping between the second codec bitrate 206 and a RSRP or a second pathloss associated with the second terminal device 120 from the second network device 140. The second terminal device 120 may determine the second codec bitrate 206 based on the mapping and the RSRP or the second pathloss.

For example, from the second terminal device 120's point of view, the supported maximum bitrate change can be determined with the below two ways:
Option1: The second terminal device 120 reports the measurement RSRP as well as the negotiated max bitrate R0 to the second network device 140, and the second network device 140 determines the change of the maximum supported bitrate and sends the changed max bitrate R3/R4 to the second terminal device 120.
Option2: The second network device 140 broadcasts the mapping between maximum supported bitrate and RSRP/pathloss, and the second terminal device 120 determine the maximum supported bitrate.

In some embodiments, the second terminal device 120 may send the second codec bitrate 206 to the first terminal device 110 only when the second codec bitrate 206 is different from the previous codec bitrate. For example, the second terminal device 120 may compare the maximum supported bitrate with the negotiated max bitrate, if the new determined max bitrate R3/R4 is smaller/larger than the negotiated max bitrate R0, the second terminal device 120 will send the changed max bitrate to the remote peer UE.

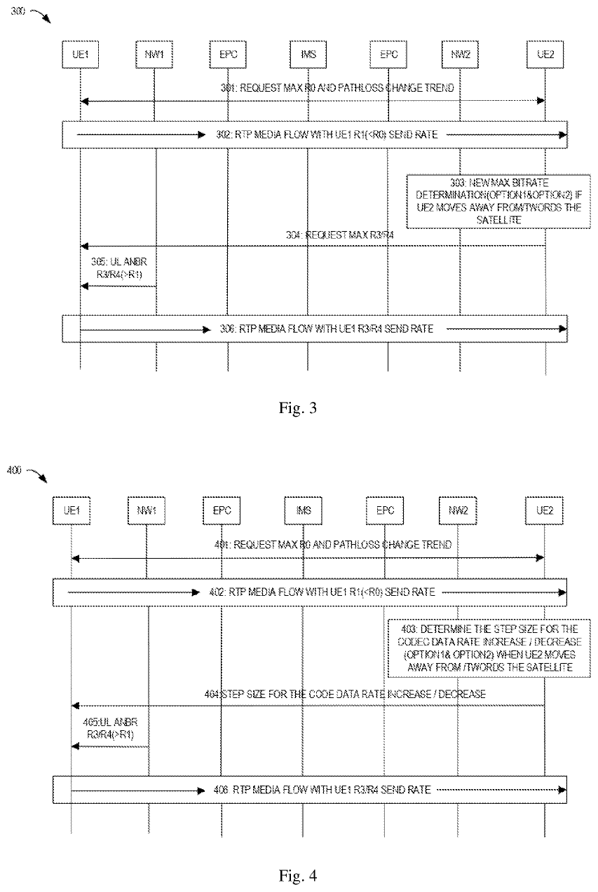

FIG. 3 illustrates an example of an optimized codec bitrate adaptation procedure which may be used in example embodiments of the present disclosure. FIG. 3 gives one new solution that the changed max bitrate is informed to the peer UE. At 301, the voice terminals (e.g., UE1 and UE2) exchange the pathloss change trend when negotiating the max bitrate R0. Furthermore, when the pathloss change trend varies in some cases, e.g., in handover, the UE will inform this information to another remote UE, e.g., via RTCP-APP.

As shown in FIG. 3, the UE2 determines new max bitrate based on the pathloss change trend, and signalling the changed max bitrate to the UE1. If one UE (e.g., UE2) is moving away from the satellite, and the supported maximum bitrate changes to R3 (R3<R0), the UE will inform the peer UE (e.g., UE1) which is communicating that the changed max bitrate R3. If one UE (e.g., UE2) is moving towards the satellite, the supported maximum bitrate changes to R4 (R4>R0), and the UE will inform the peer UE (e.g., UE1) which is communicating that the changed max bitrate R4. This information can be carried in RTP or RTCP-APP.

With this new changed max bitrate, if UE1 determines to increase the codec data rate, the new increased codec data rate will not larger than the new max bitrate of UE2. Thus avoid the ANBR procedure in UE2 when UE2 receives the increased bitrate requirement as well as reduce the packet loss.

FIG. 4 illustrates an example of another optimized codec bitrate adaptation procedure which may be used in example embodiments of the present disclosure. FIG. 4 gives another example of new solution that the step size for the max supported codec data rate increase/decrease is informed to the peer UE.

As shown in FIG. 4, the UE2 determines new max bitrate based on the pathloss change trend, and signalling the step size to the UE1. If one UE (e.g., UE2) is moving towards the satellite, the step size can be one positive value. If one UE (e.g., UE2) is moving away from the satellite, the step size can be one negative value. This can be implemented since the pathloss change trend is exchanged in 401. With the received step size, the peer UE (e.g., UE1) may derive a new maximum bitrate for UE 2 accordingly.

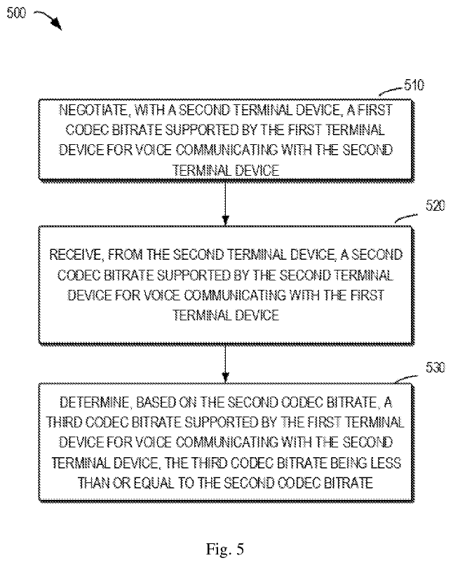

FIG. 5 illustrates a flowchart of a method 500 implemented at a terminal device according to some embodiments of the present disclosure. For the purpose of discussion, the method 500 will be described from the perspective of the first terminal device 110 with reference to FIG. 1. It is to be understood that method 500 may further include additional blocks not shown and/or omit some shown blocks, and the scope of the present disclosure is not limited in this regard.

At block 510, the first terminal device 110 may negotiate, with the second terminal device 120, a first codec bitrate supported by the first terminal device 110 for voice communicating with the second terminal device 120. At block 520, the first terminal device 110 may receive, from the second terminal device 120, a second codec bitrate supported by the second terminal device 120 for voice communicating with the first terminal device 110. At block 530, the first terminal device 110 may determine, based on the second codec bitrate, a third codec bitrate supported by the first terminal device 110 for voice communicating with the second terminal device 120, the third codec bitrate being less than or equal to the second codec bitrate.

In some embodiments, the first terminal device 110 may send, to the second terminal device 120 during the negotiating of the first codec bitrate, a first change trend of a first channel condition between a first network device 130 serving the first terminal device 110 and the first terminal device 110; and receive, from the second terminal device 120 during the negotiating of the first codec bitrate, a second change trend of a second channel condition between a second network device 140 serving the second terminal device 120 and the second terminal device 120.

In some embodiments, the first channel condition is a first pathloss associated with the first terminal device, and the first pathloss decreasing corresponds to the first channel condition becoming better, the first pathloss increasing corresponds to the first channel condition becoming worse; or the second channel condition is a second pathloss associated with the second terminal device, and the second pathloss decreasing corresponds to the second channel condition becoming better, the second pathloss increasing corresponds to the second channel condition becoming worse.

In some embodiments, the first terminal device 110 may receive the second codec bitrate by receiving, from the second terminal device 120, a step size of a change to a previous codec bitrate supported by the second terminal device for voice communicating with the first terminal device; and determining the second codec bitrate based on the previous codec bitrate and the step size.

In some embodiments, the first terminal device 110 may determine the step size by: based on determining that the second network device is moving towards the second terminal device, determining the step size as a positive value; and based on determining that the second network device is moving away from the second terminal device, determining the step size as a negative value.

In some embodiments, the first terminal device 110 may determine the second codec bitrate by: based on determining that the second change trend indicates a decrease of the second pathloss, increasing the previous codec bitrate by the step size to obtain the second codec bitrate; and based on determining that the second change trend indicates an increase of the second pathloss, decreasing the previous codec bitrate by the step size to obtain the second codec bitrate.

In some embodiments, the first terminal device 110 may at least one of: based on determining that the first change trend varies, send information indicating that the first change trend varies to the second terminal device 120; or receive, from the second terminal device 120, information indicating that the second change trend varies. In some embodiments, the first terminal device 110 may determine the third codec bitrate by: sending the second codec bitrate to the first network device 130 serving the first terminal device 110; and receiving the third codec bitrate from the first network device 130.

In some embodiments, the first terminal device 110 may determine the third codec bitrate by: receiving, from the first network device 130 serving the first terminal device 110, a fourth codec bitrate supported by the first terminal device 110 for voice communicating with the second terminal device 120; and determining a smaller one of the second codec bitrate and the fourth codec bitrate as the third codec bitrate. In some embodiments, at least one of: the second codec bitrate is carried in a codec mode request (CMR) in a real-time transport protocol (RTP) or carried in an application-defined real-time transport protocol control protocol packet (RTCP-APP) message; or the third codec bitrate is carried in a recommended bit rate medium access control (MAC) control element (CE).

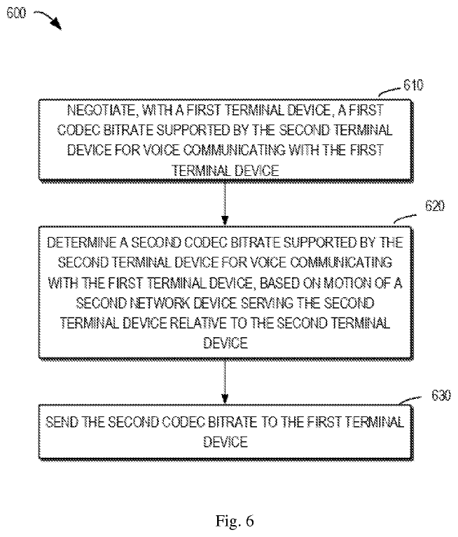

FIG. 6 illustrates a flowchart of a method implemented at a terminal device according to some embodiments of the present disclosure. For the purpose of discussion, the method 600 will be described from the perspective of the second terminal device 120 with reference to FIG. 1. It is to be understood that method 600 may further include additional blocks not shown and/or omit some shown blocks, and the scope of the present disclosure is not limited in this regard.

At block 610, the second terminal device 120 may negotiate, with the first terminal device 110, a first codec bitrate supported by the second terminal device 120 for voice communicating with the first terminal device 110. At block 620, the second terminal device 120 may determine a second codec bitrate supported by the second terminal device 120 for voice communicating with the first terminal device 110, based on motion of the second network device 140 serving the second terminal device 120 relatives to the second terminal device 120. At block 630, the second terminal device 120 may send the second codec bitrate to the first terminal device 110.

In some embodiments, the second terminal device 120 may receive, from the first terminal device 110 during the negotiating of the first codec bitrate, a first change trend of a first channel condition between a first network device 130 serving the first terminal device 110 and the first terminal device 110; and sending, to the first terminal device 110 during the negotiating of the first codec bitrate, a second change trend of a second pathloss associated with the second terminal device 120.

In some embodiments, the first channel condition is a first pathloss associated with the first terminal device, and the first pathloss decreasing corresponds to the first channel condition becoming better, the first pathloss increasing corresponds to the first channel condition becoming worse; or the second channel condition is a second pathloss associated with the second terminal device, and the second pathloss decreasing corresponds to the second channel condition becoming better, a the second pathloss increasing corresponds to the second channel condition becoming worse.

In some embodiments, the second terminal device 120 may determine the second codec bitrate by: based on determining that the second network device 140 is moving towards the second terminal device 120, increasing the previous codec bitrate to obtain the second codec bitrate; and based on determining that the second network device 140 is moving away from the second terminal device 120, reducing the previous codec bitrate to obtain the second codec bitrate. In some embodiments, the second terminal device 120 may determine the second codec bitrate by: determining a step size of a change from the previous codec bitrate to the second codec bitrate.

In some embodiments, the second terminal device 120 may determine the step size by: based on determining that the second network device 140 is moving towards the second terminal device 120, determining the step size as a positive value; and based on determining that the second network device 140 is moving away from the second terminal device 120, determining the step size as a negative value. In some embodiments, the second terminal device 120 may send the second codec bitrate by sending the step size to the first terminal device 110.

In some embodiments, the second terminal device 120 may send the second codec bitrate by: determining, based on the first change trend, that the first pathloss associated with the first terminal device 110 is decreased; and based on determining that the first pathloss is decreased, sending the second codec bitrate to the first terminal device 110. In some embodiments, the second terminal device 120 may at least one of: based on determining that the second change trend varies, send information indicating that the second change trend varies to the first terminal device 110; or receive, from the first terminal device 110, information indicating that the first change trend varies.

In some embodiments, the second terminal device 120 may determine the second codec bitrate by: sending, to the second network device 140, a reference signal receiving power (RSRP) or a second pathloss associated with the second terminal device 120 and the previous codec bitrate; and receiving the second codec bitrate from the second network device 140. In some embodiments, the second terminal device 120 may determine the second codec bitrate by: receiving, from the second network device 140, a mapping between the second codec bitrate and a RSRP or a second pathloss associated with the second terminal device 120; and determining the second codec bitrate based on the mapping and the RSRP or the second pathloss.

In some embodiments, the second terminal device 120 may send the second codec bitrate by: based on determining that the second codec bitrate is different from the previous codec bitrate, sending the second codec bitrate to the first terminal device 110. In some embodiments, at least one of: the second codec bitrate is carried in a codec mode request (CMR) in a real-time transport protocol (RTP) or carried in an application-defined real-time transport protocol control protocol packet (RTCP-APP) message; or the third codec bitrate is carried in a recommended bit rate medium access control (MAC) control element (CE).

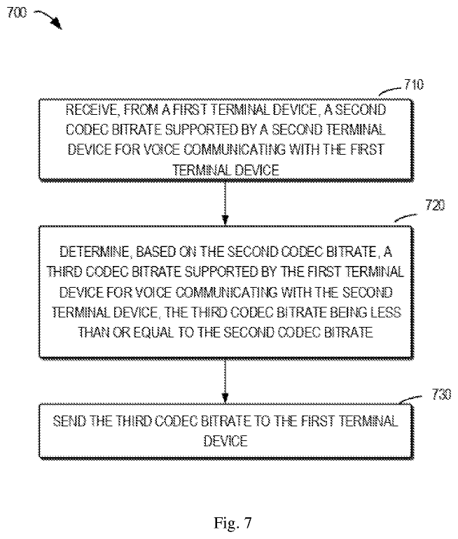

FIG. 7 illustrates a flowchart of a method implemented at a network device according to some embodiments of the present disclosure. For the purpose of discussion, the method 700 will be described from the perspective of the first network device 130 with reference to FIG. 1. It is to be understood that method 700 may further include additional blocks not shown and/or omit some shown blocks, and the scope of the present disclosure is not limited in this regard.

At block 710, the first network device 130 may receive, from the first terminal device 110, a second codec bitrate supported by the second terminal device 120 for voice communicating with the first terminal device 110. At block 720, the first network device 130 may determine, based on the second codec bitrate, a third codec bitrate supported by the first terminal device 110 for voice communicating with the second terminal device 120, the third codec bitrate being less than or equal to the second codec bitrate. At block 730, the first network device 130 may send the third codec bitrate to the first terminal device 110.

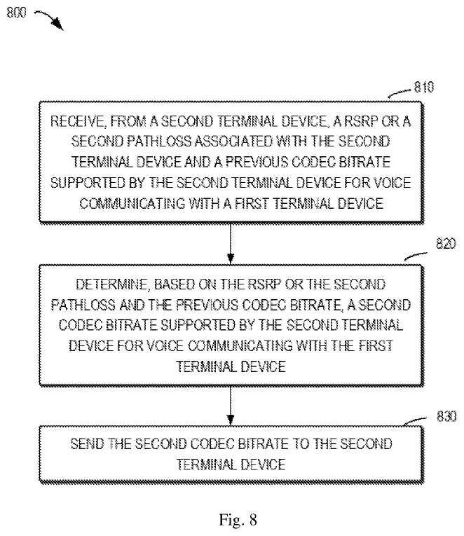

FIG. 8 illustrates a flowchart of a method implemented at a network device according to some embodiments of the present disclosure. For the purpose of discussion, the method 800 will be described from the perspective of the second network device 140 with reference to FIG. 1. It is to be understood that method 800 may further include additional blocks not shown and/or omit some shown blocks, and the scope of the present disclosure is not limited in this regard.

At block 810, the second network device 140 may receive, from the second terminal device 120, a reference signal receiving power (RSRP) or a second pathloss associated with the second terminal device 120 and a previous codec bitrate supported by the second terminal device 120 for voice communicating with the first terminal device 110. At block 820, the second network device 140 may determine, based on the RSRP or the second pathloss and the previous codec bitrate, a second codec bitrate supported by the second terminal device 120 for voice communicating with the first terminal device 110. At block 830, the second network device 140 may send the second codec bitrate to the second terminal device 120.

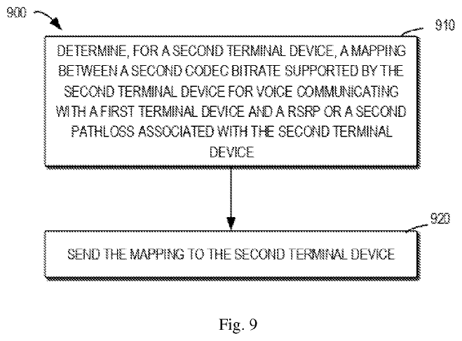

FIG. 9 illustrates a flowchart of a method implemented at a network device according to some embodiments of the present disclosure. For the purpose of discussion, the method 900 will be described from the perspective of the second network device 140 with reference to FIG. 1. It is to be understood that method 900 may further include additional blocks not shown and/or omit some shown blocks, and the scope of the present disclosure is not limited in this regard.

At block 910, the second network device 140 may determine, for the second terminal device 120, a mapping between a second codec bitrate supported by the second terminal device 120 for voice communicating with the first terminal device 110 and a reference signal receiving power (RSRP) or a second pathloss associated with the second terminal device 120. At block 920, the second network device 140 may send the mapping to the second terminal device 120.

In some embodiments, an apparatus capable of performing any of the method 500 (for example, the first terminal device 110) may comprise means for performing the respective steps of the method 500. The means may be implemented in any suitable form. For example, the means may be implemented in a circuitry or software module.

In some embodiments, the apparatus comprises: means for negotiating, at a first terminal device with a second terminal device, a first codec bitrate supported by the first terminal device for voice communicating with the second terminal device; means for receiving, from the second terminal device, a second codec bitrate supported by the second terminal device for voice communicating with the first terminal device; and means for determining, based on the second codec bitrate, a third codec bitrate supported by the first terminal device for voice communicating with the second terminal device, the third codec bitrate being less than or equal to the second codec bitrate.

In some embodiments, the apparatus further comprises: means for sending, to the second terminal device during the negotiating of the first codec bitrate, a first change trend of a first channel condition between a first network device serving the first terminal device and the first terminal device; and means for receiving, from the second terminal device during the negotiating of the first codec bitrate, a second change trend of a second channel condition between a second network device serving the second terminal device and the second terminal device.

In some embodiments, the first channel condition is a first pathloss associated with the first terminal device, and the first pathloss decreasing corresponds to the first channel condition becoming better, the first pathloss increasing corresponds to the first channel condition becoming worse; or the second channel condition is a second pathloss associated with the second terminal device, and the second pathloss decreasing corresponds to the second channel condition becoming better, the second pathloss increasing corresponds to the second channel condition becoming worse.

In some embodiments, the means for receiving the second codec bitrate comprises: means for receiving, from the second terminal device, a step size of a change to the previous codec bitrate supported by the second terminal device for voice communicating with the first terminal device; and means for determining the second codec bitrate based on the previous codec bitrate and the step size.

In some embodiments, the means for determining the step size comprises: means for based on determining that the second network device is moving towards the second terminal device, determining the step size as a positive value; and means for based on determining that the second network device is moving away from the second terminal device, determining the step size as a negative value.

In some embodiments, the means for determining the second codec bitrate comprises: means for based on determining that the second change trend indicates a decrease of the second pathloss, increasing the previous codec bitrate by the step size to obtain the second codec bitrate; and means for based on determining that the second change trend indicates an increase of the second pathloss, decreasing the previous codec bitrate by the step size to obtain the second codec bitrate.

In some embodiments, the apparatus further comprises at least one of: means for sending information indicating that the first change trend varies to the second terminal device based on determining that the first change trend varies; or means for receiving, from the second terminal device, information indicating that the second change trend varies.

In some embodiments, the means for determining the third codec bitrate comprises: means for sending the second codec bitrate to a first network device serving the first terminal device; and means for receiving the third codec bitrate from the first network device.

In some embodiments, the means for determining the third codec bitrate comprises: means for receiving, from a first network device serving the first terminal device, a fourth codec bitrate supported by the first terminal device for voice communicating with the second terminal device; and means for determining a smaller one of the second codec bitrate and the fourth codec bitrate as the third codec bitrate.

In some embodiments, at least one of: the second codec bitrate is carried in a codec mode request (CMR) in a real-time transport protocol (RTP) or carried in an application-defined real-time transport protocol control protocol packet (RTCP-APP) message; or the third codec bitrate is carried in a recommended bit rate medium access control (MAC) control element (CE).

In some embodiments, the apparatus further comprises means for performing other steps in some embodiments of the method 500. In some embodiments, the means comprises at least one processor; and at least one memory including computer program code, the at least one memory and computer program code configured to, with the at least one processor, cause the performance of the apparatus.

In some embodiments, an apparatus capable of performing any of the method 600 (for example, the second terminal device 120) may comprise means for performing the respective steps of the method 600. The means may be implemented in any suitable form. For example, the means may be implemented in a circuitry or software module.

In some embodiments, the apparatus comprises: means for negotiating, at a second terminal device with a first terminal device, a first codec bitrate supported by the second terminal device for voice communicating with the first terminal device; means for determining a second codec bitrate supported by the second terminal device for voice communicating with the first terminal device, based on motion of a second network device serving the second terminal device relative to the second terminal device; and means for sending the second codec bitrate to the first terminal device.

In some embodiments, the apparatus further comprises: means for receiving, from the first terminal device during the negotiating of the first codec bitrate, a first change trend of a first channel condition between a first network device serving the first terminal device and the first terminal device; and means for sending, to the first terminal device during the negotiating of the first codec bitrate, a second change trend of a second channel condition between a second network device serving the second terminal device and the second terminal device.

In some embodiments, the first channel condition is a first pathloss associated with the first terminal device, and the first pathloss decreasing corresponds to the first channel condition becoming better, the first pathloss increasing corresponds to the first channel condition becoming worse; or the second channel condition is a second pathloss associated with the second terminal device, and the second pathloss decreasing corresponds to the second channel condition becoming better, the second pathloss increasing corresponds to the second channel condition becoming worse.

In some embodiments, the means for determining the second codec bitrate comprises: means for based on determining that the second network device is moving towards the second terminal device, increasing the previous codec bitrate to obtain the second codec bitrate; and means for based on determining that the second network device is moving away from the second terminal device, reducing the previous codec bitrate to obtain the second codec bitrate.

In some embodiments, the means for determining the second codec bitrate comprises: means for determining a step size of a change from the previous codec bitrate to the second codec bitrate.

In some embodiments, the means for determining the step size comprises: means for based on determining that the second network device is moving towards the second terminal device, determining the step size as a positive value; and means for based on determining that the second network device is moving away from the second terminal device, determining the step size as a negative value.

In some embodiments, the means for sending the second codec bitrate comprises: means for sending the step size to the first terminal device.

In some embodiments, the means for sending the second codec bitrate comprises: means for determining, based on the first change trend, that the first pathloss associated with the first terminal device is decreased; and means for based on determining that the first pathloss is decreased, sending the second codec bitrate to the first terminal device.

In some embodiments, the apparatus comprises at least one of: means for based on determining that the second change trend varies, sending information indicating that the second change trend varies to the first terminal device; or means for receiving, from the first terminal device, information indicating that the first change trend varies.

In some embodiments, the means for determining the second codec bitrate comprises: means for sending, to the second network device, a reference signal receiving power (RSRP) or the second pathloss associated with the second terminal device and the previous codec bitrate; and means for receiving the second codec bitrate from the second network device.

In some embodiments, the means for determining the second codec bitrate comprises: means for receiving, from the second network device, a mapping between the second codec bitrate and a RSRP or a second pathloss associated with the second terminal device; and means for determining the second codec bitrate based on the mapping and the RSRP or the second pathloss.

In some embodiments, the means for sending the second codec bitrate comprises: means for based on determining that the second codec bitrate is different from the previous codec bitrate, sending the second codec bitrate to the first terminal device.

In some embodiments, at least one of: the second codec bitrate is carried in a codec mode request (CMR) in a real-time transport protocol (RTP) or carried in an application-defined RTP control protocol packet (RTCP-APP) message; or the third codec bitrate is carried in a recommended bit rate medium access control (MAC) control element (CE).

In some embodiments, the apparatus further comprises means for performing other steps in some embodiments of the method 600. In some embodiments, the means comprises at least one processor; and at least one memory including computer program code, the at least one memory and computer program code configured to, with the at least one processor, cause the performance of the apparatus.

In some embodiments, an apparatus capable of performing any of the method 700 (for example, the first network device 130) may comprise means for performing the respective steps of the method 700. The means may be implemented in any suitable form. For example, the means may be implemented in a circuitry or software module.

In some embodiments, the apparatus comprises: means for receiving, at a first network device from a first terminal device, a second codec bitrate supported by a second terminal device for voice communicating with the first terminal device; means for determining, based on the second codec bitrate, a third codec bitrate supported by the first terminal device for voice communicating with the second terminal device, the third codec bitrate being less than or equal to the second codec bitrate; and means for sending the third codec bitrate to the first terminal device.

In some embodiments, the apparatus further comprises means for performing other steps in some embodiments of the method 700. In some embodiments, the means comprises at least one processor; and at least one memory including computer program code, the at least one memory and computer program code configured to, with the at least one processor, cause the performance of the apparatus.

In some embodiments, an apparatus capable of performing any of the method 800 (for example, the second network device 140) may comprise means for performing the respective steps of the method 800. The means may be implemented in any suitable form. For example, the means may be implemented in a circuitry or software module.

In some embodiments, the apparatus comprises: means for receiving, at a second network device from a second terminal device, a reference signal receiving power (RSRP) or a second pathloss associated with the second terminal device and a previous codec bitrate supported by the second terminal device for voice communicating with a first terminal device; means for determining, based on the RSRP or the second pathloss and the previous codec bitrate, a second codec bitrate supported by the second terminal device for voice communicating with the first terminal device; and means for sending the second codec bitrate to the second terminal device.

In some embodiments, the apparatus further comprises means for performing other steps in some embodiments of the method 800. In some embodiments, the means comprises at least one processor; and at least one memory including computer program code, the at least one memory and computer program code configured to, with the at least one processor, cause the performance of the apparatus.

In some embodiments, an apparatus capable of performing any of the method 900 (for example, the second network device 140) may comprise means for performing the respective steps of the method 900. The means may be implemented in any suitable form. For example, the means may be implemented in a circuitry or software module.

In some embodiments, the apparatus comprises: means for determining, at a second network device for a second terminal device, a mapping between a second codec bitrate supported by the second terminal device for voice communicating with a first terminal device and a reference signal receiving power (RSRP) or a second pathloss associated with the second terminal device; and means for sending the mapping to the second terminal device.

In some embodiments, the apparatus further comprises means for performing other steps in some embodiments of the method 900. In some embodiments, the means comprises at least one processor; and at least one memory including computer program code, the at least one memory and computer program code configured to, with the at least one processor, cause the performance of the apparatus.

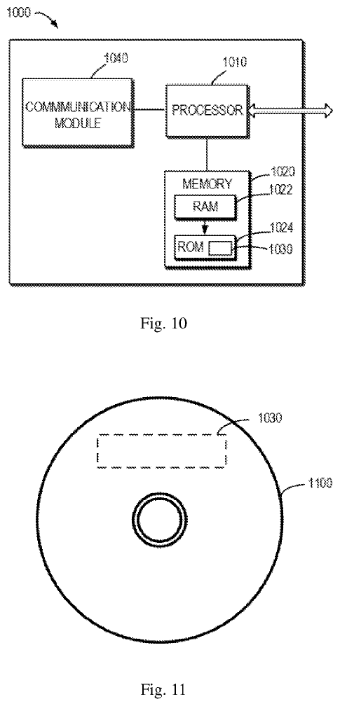

FIG. 10 is a simplified block diagram of a device 1000 that is suitable for implementing embodiments of the present disclosure. The device 1000 may be provided to implement the communication device, for example the first terminal device 110, the second terminal device 120, the first network device 130, the second network device 140 as shown in FIG. 1. As shown, the device 1000 includes one or more processors 1010, one or more memories 1020 coupled to the processor 1010, and one or more communication modules 1040 coupled to the processor 1010.

The communication module 1040 is for bidirectional communications. The communication module 1040 has at least one antenna to facilitate communication. The communication interface may represent any interface that is necessary for communication with other network elements.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a Read Only Memory (ROM) 1024, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1022 and other volatile memories that will not last in the power-down duration.

A computer program 1030 includes computer executable instructions that are executed by the associated processor 1010. The program 1030 may be stored in the ROM 1024. The processor 1010 may perform any suitable actions and processing by loading the program 1030 into the RAM 1022.

The embodiments of the present disclosure may be implemented by means of the program 1030 so that the device 1000 may perform any process of the disclosure as discussed with reference to FIGS. 2 to 9. The embodiments of the present disclosure may also be implemented by hardware or by a combination of software and hardware.

In some embodiments, the program 1030 may be tangibly contained in a computer readable medium which may be included in the device 1000 (such as in the memory 1020) or other storage devices that are accessible by the device 1000. The device 1000 may load the program 1030 from the computer readable medium to the RAM 1022 for execution. The computer readable medium may include any types of tangible non-volatile storage, such as ROM, EPROM, a flash memory, a hard disk, CD, DVD, and the like. FIG. 11 shows an example of the computer readable medium 1100 in form of CD or DVD. The computer readable medium has the program 1030 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out procedure 200, 300 or 400, or the method 500, 600, 700, 800 or 900 as described above with reference to FIGS. 2-9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first terminal device comprising:
at least one processor; and
at least one memory storing instructions that, when executed by the at least one processor, cause the first terminal device at least to:
negotiate, with a second terminal device, a first codec bitrate supported by the first terminal device for voice communicating with the second terminal device;
receive, from the second terminal device, a second codec bitrate supported by the second terminal device for voice communicating with the first terminal device; and
determine, based on the second codec bitrate, a third codec bitrate supported by the first terminal device for voice communicating with the second terminal device, the third codec bitrate being less than or equal to the second codec bitrate.

2. The first terminal device of claim 1, wherein the first terminal device is further caused to:
send, to the second terminal device during the negotiating of the first codec bitrate, a first change trend of a first channel condition between a first network device serving the first terminal device and the first terminal device; and
receive, from the second terminal device during the negotiating of the first codec bitrate, a second change trend of a second channel condition between a second network device serving the second terminal device and the second terminal device.

3. The first terminal device of claim 2, wherein at least one of:
the first channel condition is a first pathloss associated with the first terminal device, and the first pathloss decreasing corresponds to the first channel condition becoming better, the first pathloss increasing corresponds to the first channel condition becoming worse; or
the second channel condition is a second pathloss associated with the second terminal device, and the second pathloss decreasing corresponds to the second channel condition becoming better, the second pathloss increasing corresponds to the second channel condition becoming worse.

4. The first terminal device of claim 1, wherein the first terminal device is caused to receive the second codec bitrate by:
receiving, from the second terminal device, a step size of a change to a previous codec bitrate supported by the second terminal device for voice communicating with the first terminal device; and
determining the second codec bitrate based on the previous codec bitrate and the step size.

5. The first terminal device of claim 4, wherein the first terminal device is caused to determine the step size by:
based on determining that the second network device is moving towards the second terminal device, determining the step size as a positive value; and
based on determining that the second network device is moving away from the second terminal device, determining the step size as a negative value.

6. The first terminal device of claim 4, wherein the first terminal device is caused to determine the second codec bitrate by:
based on determining that the second change trend indicates a decrease of the second pathloss, increasing the previous codec bitrate by the step size to obtain the second codec bitrate; and
based on determining that the second change trend indicates an increase of the second pathloss, decreasing the previous codec bitrate by the step size to obtain the second codec bitrate.

7. The first terminal device of claim 2, wherein the first terminal device is further caused to at least one of:
based on determining that the first change trend varies, send information indicating that the first change trend varies to the second terminal device; or
receive, from the second terminal device, information indicating that the second change trend varies.

8. The first terminal device of claim 1, wherein the first terminal device is caused to determine the third codec bitrate by:
sending the second codec bitrate to a first network device serving the first terminal device; and
receiving the third codec bitrate from the first network device.

9. The first terminal device of claim 1, wherein the first terminal device is caused to determine the third codec bitrate by:
receiving, from a first network device serving the first terminal device, a fourth codec bitrate supported by the first terminal device for voice communicating with the second terminal device; and
determining a smaller one of the second codec bitrate and the fourth codec bitrate as the third codec bitrate.

10. (canceled)

11. A second terminal device comprising:
at least one processor; and
at least one memory storing instructions that, when executed by the at least one processor, cause the second terminal device at least to:
negotiate, with a first terminal device, a first codec bitrate supported by the second terminal device for voice communicating with the first terminal device;
determine a second codec bitrate supported by the second terminal device for voice communicating with the first terminal device, based on motion of a second network device serving the second terminal device relative to the second terminal device; and
send the second codec bitrate to the first terminal device.

12. The second terminal device of claim 11, wherein the second terminal device is further caused to:
receive, from the first terminal device during the negotiating of the first codec bitrate, a first change trend of a first channel condition between a first network device serving the first terminal device and the first terminal device; and
send, to the first terminal device during the negotiating of the first codec bitrate, a second change trend of a second channel condition between a second network device serving the second terminal device and the second terminal device.

13. (canceled)

14. The second terminal device of claim 11, wherein the second terminal device is caused to determine the second codec bitrate by:
based on determining that the second network device is moving towards the second terminal device, increasing a previous codec bitrate supported by the second terminal device for voice communicating with the first terminal device to obtain the second codec bitrate; and
based on determining that the second network device is moving away from the second terminal device, reducing the previous codec bitrate to obtain the second codec bitrate.

15. The second terminal device of claim 12, wherein the second terminal device is caused to determine the second codec bitrate by:
determining a step size of a change from the previous codec bitrate to the second codec bitrate.

16. The second terminal device of claim 15, wherein the second terminal device is caused to determine the step size by:
based on determining that the second network device is moving towards the second terminal device, determining the step size as a positive value; and
based on determining that the second network device is moving away from the second terminal device, determining the step size as a negative value.

17. The second terminal device of claim 15, wherein the second terminal device is caused to send the second codec bitrate by:
sending the step size to the first terminal device.

18. The second terminal device of claim 15, wherein the second terminal device is caused to send the second codec bitrate by:
determining, based on the first change trend, that the first pathloss associated with the first terminal device is decreased; and
based on determining that the first pathloss is decreased, sending the second codec bitrate to the first terminal device.

19. The second terminal device of claim 12, wherein the second terminal device is further caused to at least one of:
based on determining that the second change trend varies, send information indicating that the second change trend varies to the first terminal device; or
receive, from the first terminal device, information indicating that the first change trend varies.

20. The second terminal device of claim 11, wherein the second terminal device is caused to determine the second codec bitrate by:
sending, to the second network device, a reference signal receiving power (RSRP) or the second pathloss associated with the second terminal device and the previous codec bitrate; and
receiving the second codec bitrate from the second network device.

21. The second terminal device of claim 11, wherein the second terminal device is caused to determine the second codec bitrate by:
receiving, from the second network device, a mapping between the second codec bitrate and a RSRP or a second pathloss associated with the second terminal device; and
determining the second codec bitrate based on the mapping and the RSRP or the second pathloss.

22. The second terminal device of claim 11, wherein the second terminal device is caused to send the second codec bitrate by:
based on determining that the second codec bitrate is different from the previous codec bitrate, sending the second codec bitrate to the first terminal device.

23-37. (canceled)
